(19) United States
(12) Patent Application Publication
(10) Pub. No.: US 2023/0130497 A1
(43) Pub. Date: Apr. 27, 2023

(54) BATTERY PACK WITH SINGLE-SIDED WIRE BONDING

(71) Applicants: Briggs & Stratton, LLC, Wauwatosa, WI (US); Briggs & Stratton (Shanghai) International Trading Co., Ltd., Qing Pu Industrial Zone, Shanghai (CN)

(72) Inventors: Jeffrey H. Whitmore, Wauwatosa, WI (US); Shaoban Wu, Qing Pu Industrial Zone (CN); Haijiang Liu, Qing Pu Industrial Zone (CN); Yongkai Li, Qing Pu Industrial Zone (CN)

(73) Assignees: Briggs & Stratton, LLC, Wauwatosa, WI (US); Briggs & Stratton (Shanghai) International Trading Co., Ltd., Qing Pu Industrial Zone, Shanghai (CN)

(21) Appl. No.: 17/798,706

(22) PCT Filed: Feb. 11, 2020
(86) PCT No.: PCT/CN2020/074715

§ 371 Date: Aug. 10, 2022

(51) Int. Cl. H01M 50/204; H01M 10/48; H01M 50/516

(52) U.S. Cl. CPC H01M 50/204; H01M 10/482; H01M 50/516; H01M 2010/4271

(57) ABSTRACT

A battery pack for powering equipment includes a core battery pack. The core battery pack includes a housing and a battery cell assembly positioned within the housing of the core battery pack. The battery cell assembly includes a first collector plate, a second collector plate, multiple battery cells, and multiple wire bonds. Each of the multiple battery cells has a first end and a second end. Each of the multiple wire bonds electrically connects the first end of one of the multiple battery cells to the first collector plate. None of the multiple wire bonds are coupled to a second end of one of the multiple battery cells.

### BACKGROUND

The present invention generally relates to the field of indoor and outdoor power equipment, and in particular, to the field of battery powered indoor and outdoor power equipment.

### SUMMARY

One embodiment of the present disclosure is a battery pack for powering equipment, the battery pack including a core battery pack. The core battery pack includes a housing and a battery cell assembly positioned within the housing of the core battery pack. The battery cell assembly includes a first collector plate, a second collector plate, multiple battery cells, and multiple wire bonds. Each of the multiple battery cells has a first end and a second end. Each of the multiple wire bonds electrically connects the first end of one of the battery cells to the first collector plate. None of the wire bonds are coupled to a second end of one of the battery cells.

Another embodiment of the present disclosure is a battery pack including a housing and a battery cell assembly. The battery cell assembly includes a first collector plate, a second collector plate, and multiple battery cells. Each of the battery cells has a first end and a second end. The first end of each of the battery cells is physically and electrically connected to the first collector plate by a wire bond. No wire bond is physically and electrically connected to the second end of one of the battery cells to the second collector plate.

Another embodiment of the present disclosure includes a battery pack for powering equipment, the battery pack including a core battery pack and a battery cell assembly. The core battery pack has a housing and the battery cell assembly is positioned within the housing of the core battery pack. The battery cell assembly includes a first collector plate, a second collector plate, multiple battery cells, and a battery management system (BMS). The first collector plate and the second collector plate are electrically connected to the BMS via multiple voltage taps for measuring voltage readings of the multiple battery cells.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1 is a perspective view of a battery assembly for use with various types of indoor and outdoor power equipment.

FIG. 2 is an exploded view of the battery pack of FIG. 1.

FIG. 3 is an exploded view of the core battery pack of FIG. 1.

FIG. 4 is a zoomed-in perspective view of a first side of the first cell holder of FIG. 3.

FIG. 5 is a view of one of the first collector plates of FIG. 3.

FIG. 6 is a bottom view of a second side of the second cell holder of FIG. 3.

FIGS. 7A and 7B are zoomed-in, perspective views of resistance welding on the second side of the battery cell assembly of FIG. 3.

FIG. 8 is a perspective view of the battery cell assembly of FIG. 3 showing the arrangement of battery cells.

FIGS. 9A and 9B show perspective views of the assembly of battery cells with the first and second collector plates of FIG. 3.

FIG. 10 is a bottom view of the first cell holder of FIG. 3.

FIG. 11 is a perspective view of the second cell holder of FIG. 3.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to figures generally, the battery assembly described herein is a removable and replaceable battery assembly, which can be used with various types of indoor and outdoor power equipment. Outdoor power equipment includes lawn mowers, riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, portable generators, portable jobsite equipment, etc. Indoor power equipment includes floor sanders, floor buffers and polishers, vacuums, power tools, etc. Portable jobsite equipment includes portable light towers, mobile industrial heaters, and portable light stands.

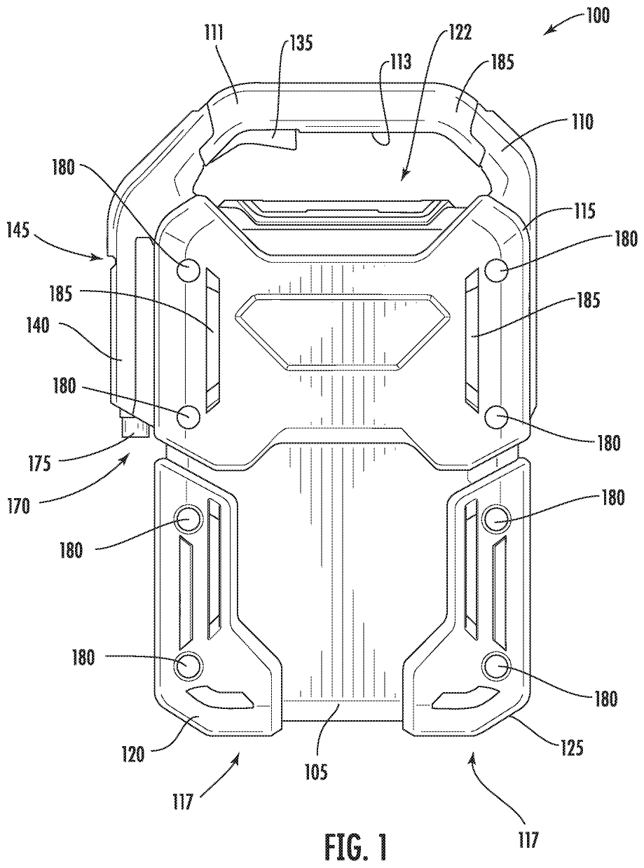

Referring to FIG. 1, the battery pack 100 is shown, according to an exemplary embodiment. The battery pack 100 is removable and rechargeable. The battery pack 100 may be configured to be coupled with an equipment interface removably mounted on a piece of equipment or inserted (e.g., dropped, lowered, placed) into a receiver including the equipment interface that is integrated with a piece of equipment and/or a charging station. The battery pack 100 may be installed into a piece of equipment vertically, horizontally, or at any angle relative to horizontal or vertical. The battery pack 100 includes a core battery pack 105 and optionally, one or more housing components and bumper modules as described below. The core battery pack 105 uses Lithium-ion battery cells. In other embodiments, other battery chemistries for the core battery pack 105 may be used, such as nickel-cadmium (NiCD), lead-acid, nickel-metal hydride (NiMH), lithium polymer, etc. In some embodiments, the battery pack 100 yields a voltage of approximately 48 Volts (V) and 1400 Watt-hours (W-hrs) of capacity. In other embodiments, it is contemplated that battery assemblies of other sizes may also be used in order to provide a different voltage rating and a greater or less amount of W-hrs. In some embodiments, the battery pack 100 in total weighs less than approximately twenty-five pounds and includes a handle, allowing for ease of portability, removal, and replacement. In some embodiments, the battery pack 100 may be less than twenty pounds in weight. In some embodiments, the battery pack 100 is also hot-swappable, meaning that a drained battery pack 100 can be exchanged for a new battery pack 100 without completely powering down connected equipment. As such, downtime of equipment operation between battery pack 100 exchanges is eliminated.

The battery pack 100 can be removed by an operator from a piece of equipment without the use of tools and recharged using a portable charger or charging station. In this way, the operator may use a second rechargeable battery having a sufficient charge to power equipment while allowing the first battery pack 100 to recharge. Additionally, the battery pack 100 can be used on various types of equipment including indoor, outdoor, and portable jobsite equipment. Due to its uniformity across various types of equipment, the battery pack 100 may also be used as part of a rental system, where rental companies who traditionally rent out pieces of power equipment may also rent the battery pack 100 to be used on such power equipment. An operator may rent a battery pack 100 to use on various types of equipment or vehicles the operator may own and/or rent and then return the battery pack 100 to be used by other operators on an as-needed basis. The operator may also rent out various equipment or chargers to be used with the battery pack 100 as well. Furthermore, multiple battery packs 100 may be used in conjunction with each other to provide a sufficient amount of power to equipment that may require more than a single battery pack 100.

The battery pack 100 is configured to be selectively and electrically coupled to an interface of a piece of power equipment and/or a charger. The piece of equipment or charging station includes an equipment interface having electrical terminals that are selectively and electrically coupled to the battery pack 100 without the use of tools. For example, an operator may both insert (and electrically couple) and remove (and electrically decouple) the battery pack 100 from a piece of equipment (e.g., from terminals of the equipment interface) without the use of tools.

Still referring to FIG. 1, the battery pack 100 includes a first, upper housing 115 coupled to the upper portion of the core battery pack 105, and a second, lower housing 117 coupled to a lower portion of the core battery pack 105. In some embodiments, the lower housing 117 includes bumper modules on each of the left and right sides. For example, the lower housing 117 includes a first bumper module 120 attached to the left side of the core battery pack 105 and a second bumper module 125 attached to the right side of the core battery pack 105. In other embodiments, the lower housing 117 includes a single bumper module that encompasses the entire bottom side of the core battery pack 105, rather than two separate bumper modules 120 and 125. In some embodiments, the upper housing 115 and the bumper modules 120, 125 of the lower housing 117 are coupled to the core battery pack 105 using fasteners 180 (e.g., bolts, screws). The upper housing 115 and the bumper modules 120 and 125 of the lower housing 117 provide protection to the core battery pack 105. In some embodiments, the upper housing 115 and the lower housing 117 are structured to absorb or limit the amount of force the core battery pack 105 endures from a fall, usage on a piece of equipment, etc. In some embodiments, the upper housing 115 includes a handle 110 for the battery pack 100. The upper housing 115 and the lower housing 117, including bumper modules 120 and 125, may form the overall housing for the battery pack 100 that substantially encompasses the housing of the core battery pack 105.

In some embodiments, the handle 110 and the upper housing 115 include flexible inserts 185 to provide further protection to the core battery pack 105. The flexible inserts 185 can help limit damage to the core battery pack 105 from external forces, such as forces exerted on the core battery pack 105 from a fall. In some embodiments, the flexible inserts 185 are made from thermoplastic elastomer (TPE) overmolding. The flexible inserts 185 may have gaps between the TPE overmolding to allow the TPE overmolding space to deflect and deform. In other embodiments, the flexible inserts 185 are made out of the same material as the upper housing 115 and bumper modules 120 and 125. The upper housing 115 and bumper modules 120 and 125 may be exchangeable and customizable such that an operator or original equipment manufacturer may chose a different design and/or color based on the type or make and model of the equipment with which the battery pack 100 is to be used. Furthermore, the exchangeability of the upper housing 115 and the bumper modules 120, 125 allow the ability of operators to replace damaged components (e.g., a broken bumper module 120). The upper housing 115 including the handle 110 and the bumper modules 120 and 125 can be detached from the core battery pack 105. As such, in some embodiments, the battery pack 100 may not include the upper housing 115 and/or the lower housing 117 with the bumper modules 120 and 125. For example, the core battery pack 105 may be permanently mounted to a piece of equipment and not need the additional capability of transporting the core battery pack 105 provided by the upper housing 115. In some embodiments, one or more battery packs 100 are used in a fixed mount environment. In addition, one or more battery packs 100 can be used in a removable and replaceable environment, such as with an electric vehicle. The battery packs 100 can be inserted into a slot of an interface on an outdoor power vehicle and can be removed by an operator by grasping the handle 110 of each battery pack 100, unlocking the battery pack 100 from the slot by moving the release mechanism on the handle 110 (e.g., movable member 135), and pulling upward and outward until the battery pack 100 is fully removed from the slot.

The upper housing 115 includes a slot 145 and a mating portion 140 including an opening 170 having one or more ports positioned therein. The ports are configured to mate with charging connectors on a charger or an equipment interface. The handle 110 includes an outer surface 111 and an inner surface 113 positioned nearer the core battery pack 105 than the outer surface 111. The inner surface 113 includes a release mechanism or movable member 135 configured to be operable by the operator to unlock and decouple the battery pack 100 from a charging station and/or a piece of equipment. When depressed, the movable member 135 moves inward toward the inner surface 113 and unlocks the battery pack 100 out of engagement with a respective feature on an interface of a piece of power equipment and/or a charger. In this way, when an operator grasps the handle 110, the operator can, at the same time and with the same hand, easily depress the movable member 135 to disengage the battery pack 100 from a piece of equipment or charging station. The handle 110 is also shown to include flexible insert 185, which may be the same material as the other flexible inserts 185 on the upper housing 115, such as TPE overmolding. In some embodiments, TPEs are also used on an interior interface between the handle 110 and housing of the core battery pack 105 to provide greater impact resistance for the core battery pack 105. In some embodiments, TPE padding is used to fill any gaps between the housing of the core battery pack 105 and the handle 110 of the upper housing 115.

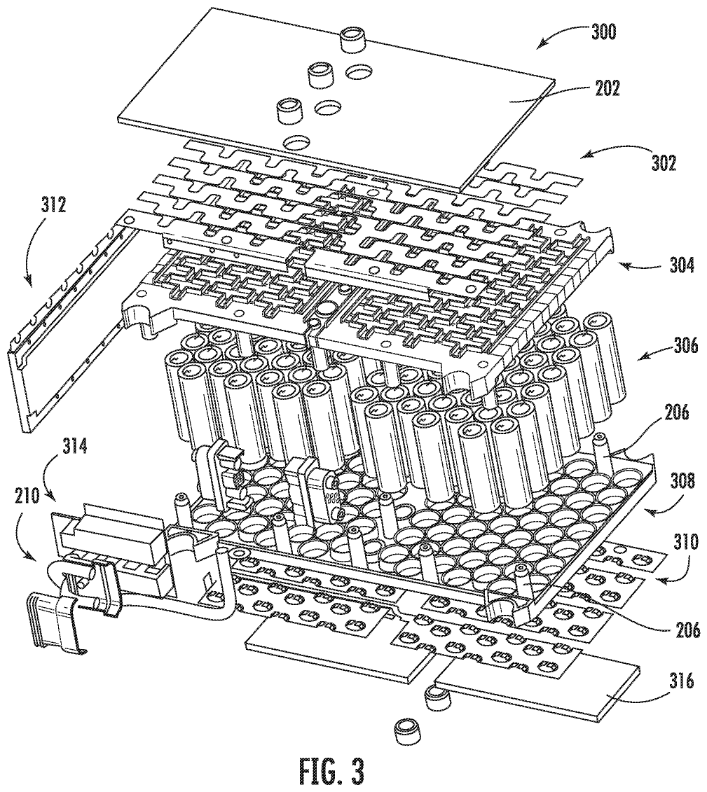

Still referring to FIG. 1, the core battery pack 105 further includes a user interface 122 configured to display various status and fault indications of the battery pack 100. The user interface 122 uses light-emitting diodes (LEDs), liquid crystal display, etc., to display various colors or other indications. The display of the user interface 122 can provide battery charge status, and can blink or flash battery fault codes. For example, when the battery management system (BMS) detects a fault in one of the battery cells 306 (FIG. 3), a warning may flash on the display of the user interface 122. The display of the user interface 122 may also provide additional information about the battery pack 100 including condition, tool specific data, usage data, faults, customization settings, etc. Furthermore, battery indications may include, but are not limited to, charge status, faults, battery health, battery life, capacity, rental time, battery mode, unique battery identifier, link systems, etc. The user interface 122 can be a customized version of a user interface tailored to a specific tool, use, or operator during a job.

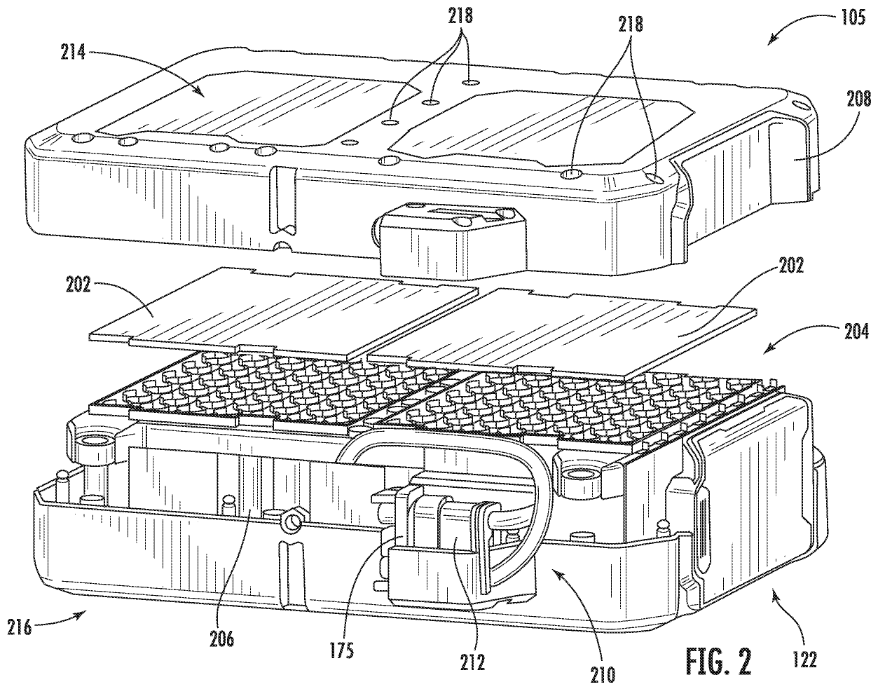

Referring now to FIG. 2, an exploded view of the core battery pack 105 is shown, according to an exemplary embodiment. The exploded view is shown to include housing 208, flexible pads 202, battery cell assembly 204, spacers 206, cable assembly 210, electrical connector 212, ports 175, and user interface 122. The flexible pads 202 may be placed between the cell assembly 204 and the housing 208 in order to provide protection to the battery cell assembly 204 during falls, use on the power equipment, etc. The power from the battery cell assembly 204 may be routed to the ports 175 via the cable assembly 210 and electrical connector 212 in order to provide power to a piece of outdoor power equipment coupled to the core battery pack 105. The spacers 206 may be inserted through apertures 218 in the core battery pack 105, extending through the core battery pack 105 from the front face 214 to the rear face 216. The spacers 206 separating the front face 214 and the rear face 216 of the core battery pack 105 may provide additional space above and below the battery cells within the battery cell assembly 204. The core battery pack 105 includes an electrical connector 212, which may include the ports 175 configured to couple with connectors on a charger, charging station, or equipment interface for a power tool. The electrical connector 212 is housed and protected within the mating portion 140 of the upper housing 115 when the upper housing 115 is attached to the core battery pack 105. Accordingly, the ports 175 are accessible through the mating portion 140 of the battery pack 100 as described above. In this way, the upper housing 115 may serve to protect the ports 175 from damage due to impacts experienced during installation on a charging station and/or onto power equipment or serve to limit the amount of debris and/or liquid reaching or contacting the ports 175.

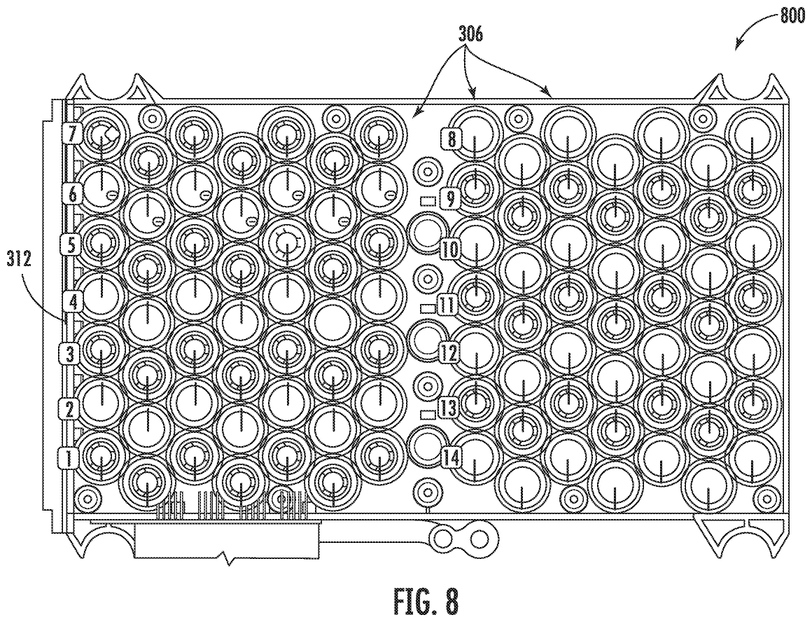

Referring, specifically to FIG. 3, an exploded view 300 of the internal components of core battery pack 105 is shown, according to an exemplary embodiment. The view 300 shows a flexible pad 202, which may be a rubber pad or foam pad to dampen the effects of a force from an impact on the core battery pack 105. In some embodiments, the battery cell assembly 204 includes, at least in part, first collector plates 302, first cell holder 304, battery cells 306, second cell holder 308, and second collector plates 310. In some embodiments, the first collector plates 302 are top collector plates positioned on the top surface of the first cell holder 304 and the second collector plates 310 are bottom collector plates positioned on the bottom surface of the second cell holder 308. The collector plates 302 and 310 electrically connect the battery cells 306 together. The collector plates 302 and 310 may also create both parallel and series electrical connections and electrically connect to the BMS 312, as described further below. The battery cells 306 may be positioned in a 7P14S configuration (i.e., seven battery cells in parallel, and fourteen series of battery cells, shown in greater detail in FIG. 8). In some embodiments, the battery cells 306 are positioned in a 6P14S configuration (i.e., six battery cells in parallel, fourteen series of battery cells). Other configurations of the battery cells 306 are also contemplated, such as with more or less battery cells positioned and connected in parallel. The battery cells 306 are positioned with spacers 206 and flexible O-rings positioned between two halves of the battery cells in the series and parallel configuration. Each of the battery cells 306 includes a first end (e.g., a top end) and a second end (e.g., a bottom end). The battery cells 306 are shown oriented vertically (i.e., each battery cell 306 has an axis extending longitudinally through an entire length of each of the battery cells 306 normal to a cross-sectional area of each of the battery cells 306). In other embodiments, battery cells 306 may be added or removed to increase or decrease the voltage capacity (V), the charge capacity (W-hrs), or to change both the voltage and the charge capacity of the core battery pack 105. In other embodiments, the battery cells 306 may be horizontally oriented.

When the core battery pack 105 is assembled, the spacers 206 are positioned on the outside of the battery cell assembly 204 and extend between the front face 214 and the rear face 216 of the core battery pack 105. The configuration of the spacers 206 relative to the battery cell assembly 204 may permit separation of the battery cell assembly 204 from the housing (e.g. housing 208) of the core battery pack 105. As such, there may be additional room for more rubber or foam pads to be placed between the housing of the core battery pack 105 and the battery cell assembly 204. As such, the core battery pack 105 may be more resistant to impacts experienced while coupled to a piece of power equipment or from a fall. The view 300 also shows the bottom flexible pads 316, which may be the same or similar as the flexible pads 202. For example, the flexible pads 316 may be made of the same material as the flexible pads 202, but of a greater or smaller thickness. In some embodiments, flexible O-rings (e.g., rubber O-rings) provide further protection and impact resistance for the core battery pack 105. The core battery pack 105 also includes BMS 312, metal-oxide semiconductor field-effect transistor (MOSFET) board 314, and cable assembly 210. The MOSFET board 314 may be electrically connected to the BMS 312 and the cable assembly 210 to provide power switching for the core battery pack 105.

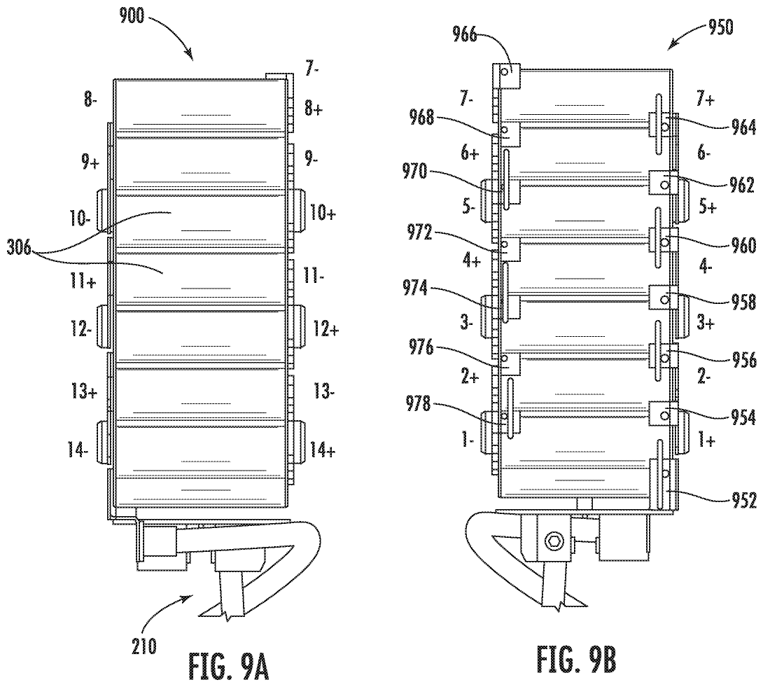

In some embodiments, the BMS 312 is positioned within the core battery pack 105 and is electrically coupled to the battery cell assembly 204. When the core battery pack 105 is assembled, the BMS 312 may be positioned proximate a location of a handle for the battery pack 100 in the upper portion of the core battery pack 105. For example, the BMS 312 may be positioned underneath the user interface 122. The BMS 312 is connected to the battery cell assembly 204 and is also connected to the first collector plates 302 and the second collector plates 310 (e.g., via voltage taps 952-978 (FIG. 9B)). In some embodiments, the electrical connection between the BMS 312 and the first collector plates 302 and the second collector plates 310 allows for a voltage reading across groups of battery cells 306 in series. Conventionally, this type of connection is made by running electrical wires across the entirety of the core battery pack 105. By using first collector plates 302 and second collector plates 310, the electrical wires that are typically used to make this electrical connection are eliminated, thereby reducing the use of wires within the core battery pack 105.

In some embodiments, the BMS 312 is configured to control usage of the core battery pack 105, detect faults in the battery cell assembly 204, and/or balance charges on the battery cells 306, in response to voltage readings from the battery cell assembly 204. The BMS 312 may be configured to manage the power output of the battery cells 306. The BMS 312 may be configured to allow the battery cells 306 to provide full power output to ports 175 in order to supply power to a piece of equipment with which the battery pack 100 is connected. In some embodiments, the BMS 312 may allow battery cells 306 to be charged when battery pack 100 is connected to charging stations or a portable charger. The BMS 312 may also be configured to shut off power output from the battery cells 306 to ports 175. In some embodiments, the BMS 312 may also be configured to record and store data regarding faults within the battery cell assembly 204, usage of the core battery pack 105, charging cycles, balancing charges of the battery cells 306, power level, rental duration, etc., of the battery pack 100. The BMS 312 may also be configured to wirelessly connect to a remote database, a remote network, or a remote device, according to some embodiments. In some embodiments, BMS 312 may further be configured to communicate and control user interface 122 in order to output information regarding the battery pack 100 and receive inputs to control the operation of the core battery pack 105. As noted above, the user interface 122 may display information to the operator, such as battery level, rental time remaining, error messages, etc. Furthermore, the BMS 312 may be configured to communicate with other circuit boards within the core battery pack 105, such as the MOSFET board 314, a near field communication (NFC) board, and/or an internet of things (IoT) board.

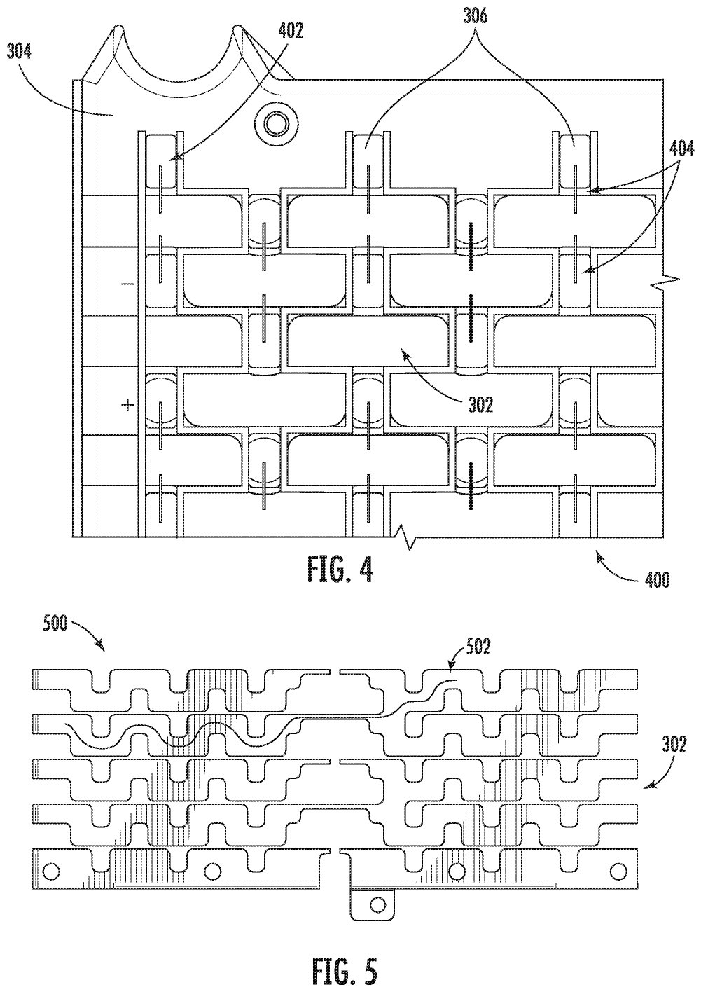

Referring now to FIG. 4, a zoomed-in perspective view 400 of a top side of the first cell holder 304 is shown, according to an exemplary embodiment. The view 400 includes a stamping check 402, the first collector plate 302, and wire bonds 404. The stamping check 402 may be used to confirm that the two pieces of the first cell holder 304 are separated in order to begin wire bonding of the first ends (e.g., top ends) of the battery cells 306 to the first collector plates 302. In some embodiments, the first collector plates 302 are overmolded into the first cell holder 304. The stamping of the first cell holder 304 may be done after the first collector plates 302 are overmolded into the first cell holder 304. In some embodiments, each first end of the battery cells 306 are electrically connected to the first collector plates 302 by wire bonds 404 on the top side of the battery cell assembly 204. None of the wire bonds 404 are coupled to the second ends of the battery cells 306 within core battery pack 105. Wire bonding on a single side (i.e., only coupling the first ends of the battery cells 306 to the first collector plates 302 with wire bonds) of the core battery pack 105 may beneficially remove a manufacturing process on the other side of the battery cell assembly 204 and the core battery pack 105. Limiting the manufacturing process to one side may reduce the amount of time needed to assemble the core battery pack 105 and the risk of damage to the components of the core battery pack 105.

Additionally, removing the use of wire bonding on the second (e.g., bottom) side of the battery cell assembly 204 decreases the sensitivity of that area in the core battery pack 105. In some embodiments, this is because wire bonds 404 that may be damaged are no longer located on both sides of the battery cell assembly 204. As such, the wire bonding on a single side of the battery cell assembly 204 can allow placement of other components on the other side of the core battery pack 105. For example, an additional heat sink (e.g., an aluminum plate, etc.) may be placed at the bottom of the core battery pack 105. The heat sink may then couple to the second cell holder 308 without risk of damage to wire bonds 404 of the core battery pack 105. The heat sink can then be used to provide heat dissipation for the core battery pack 105 to prevent the temperature of the core battery pack 105 from increasing above a threshold amount. In some embodiments, wire bonds 404 are only used on top side of the battery cell assembly 204 to couple the first ends of the battery cells 306 to the first collector plates 302. Resistance welding may then be used on the bottom side of battery cell assembly 204. For example, no wire bonds 404 are coupled to the second ends of the battery cells 306. Instead, the second ends of the battery cells 306 are coupled to the second collector plates 310 by resistance welding, according to some embodiments. Therefore, the first end and the second end of each of the battery cells 306 can be secured to the first collector plates 302 and the second collector plates 310 without the use of any glue.

In other embodiments, the wire bonds 404 used on the top side of the battery cell assembly 204 within the core battery pack 105 are used on the bottom side as well. When wire bonding is used on both sides of the battery cell assembly 204, glue also may be used on each side. The glue may be cured by an ultraviolet (UV) light to hold the battery cells 306 in place and secure the battery cells 306 to the first cell holder 304 and second cell holder 308. Each of the positions for the battery cells 306 may include three glue pockets in the first cell holder 304 to allow the glue to extend down the battery cells 306 in a seepage area. In still yet another embodiment, wire bonding may be used on the same side as resistance welding when one of the welds fail or a weld does not meet a certain standard of quality.

Referring now to FIG. 5, a view 500 of one of the first collector plates 302 within the battery cell assembly 204 is shown in greater detail, according to an exemplary embodiment. The view 500 shows an example of a voltage reading path 502 across the first collector plate 302. In some embodiments, the voltage reading path 502 allows the BMS 312 to receive the voltage measurements of the battery cells 306 in the battery cell assembly 204, without the need of additional wiring inside the core battery pack 105. In some embodiments, the first collector plates 302 receive a voltage from the electrical connection to the battery cells 306 via wire bonding (e.g., wire bonds 404) on the top side of the battery cell assembly 204. In some embodiments, the BMS 312 then receives the voltage measurement at the voltage taps coupled to the first collector plates 302, where the BMS 312 is electrically connected to the first collector plates 302 via aluminum voltage taps.

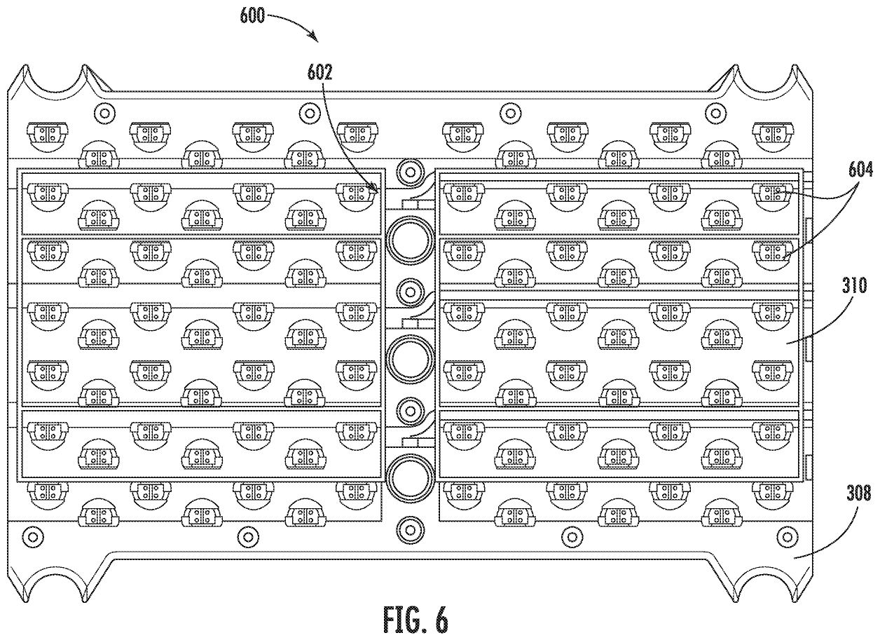

Referring to FIG. 6, a view 600 of the bottom side of the second cell holder 308 is depicted, according to an exemplary embodiment. In some embodiments, the view 600 of the second cell holder 308 shows plate 602, several pairs of metal tabs 604, second collector plates 310, and second cell holder 308. The plate 602 may be overmolded on the bottom side of the second cell holder 308. In some embodiments, the plate 602 is constructed out of nickel-plated steel. In some embodiments, the design of the plate 602 can allow the BMS 312 to read the voltage measurements at each voltage tap coupled to the second collector plates 310. In some embodiments, the second collector plates 310 include several removable pairs of metal tabs 604. Each pair of removable metal tabs 604 may be located at each position for one of battery cells 306. Each pair of removable metal tabs 604 can be physically and electrically coupled to a second end of the battery cells 306 using resistance welding. In some embodiments, resistance welding is used to replace wire bonding on a bottom side of the battery cell assembly 204 of core battery pack 105. The resistance welding of the second ends of battery cells 306 may beneficially fix cell position and provide electrical connections to the battery cells 306 for routing voltage measurements to the BMS 312.

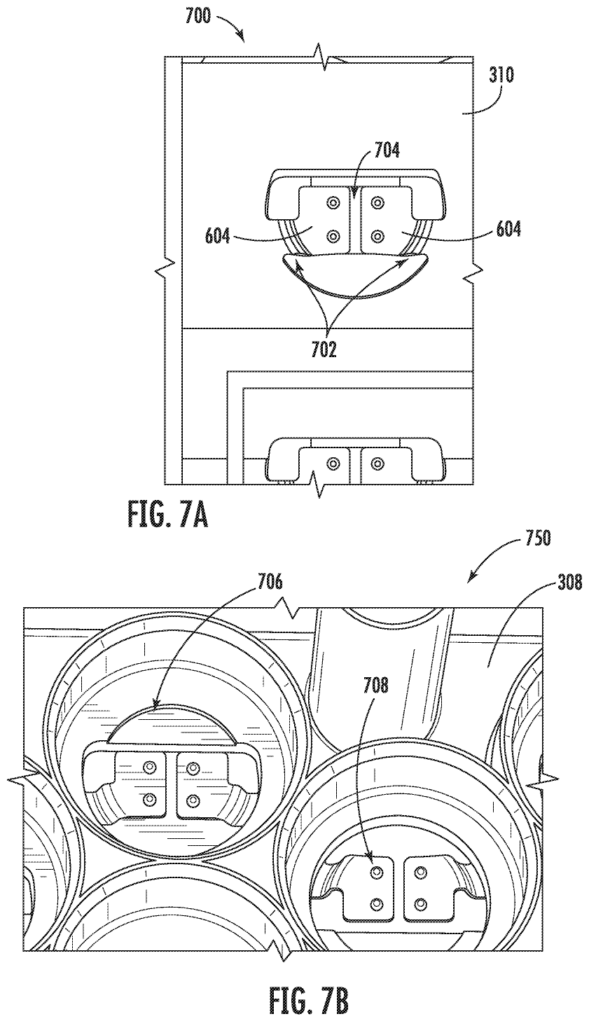

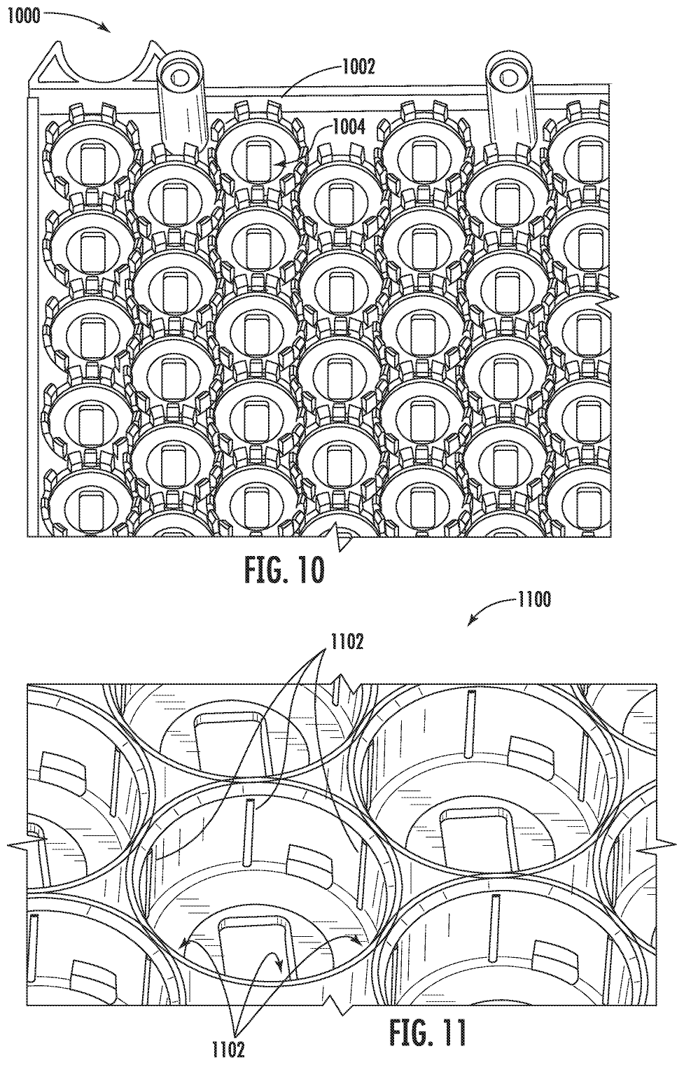

Furthermore, resistance welding may eliminate the need for any gluing and curing for prevention of cell rotation. Resistance welding may prevent rotational movement of the battery cells 306, while fingers 1002 (FIG. 10) control radial clearance. The use of resistance welding, in combination with the fingers 1002, may completely replace the use of glue during construction of the battery cell assembly 204. In some embodiments, the resistance welding may be used with thermal epoxy to decrease the amount of battery cells 306 that require resistance welding. In other embodiments, thermal epoxy may be used to replace resistance welding of the battery cells 306 on the bottom side of the core battery pack 105. FIGS. 7A and 7B show zoomed-in perspective views 700 and 750 of locations for resistance welding on the second side (e.g., bottom side) of the battery cell assembly 204, according to some embodiments.

The zoomed-in view 700 shows a bottom view of a collector plate (e.g., second collector plate 310). The view 700 includes cutting locations 702 on each of the pair of metal tabs 604 and gap 704 in between the pair of metal tabs 604. The cutting locations 702 on each of the pair of metal tabs 604 provide the capability to remove the metal tabs 604. For example, if a bond completed during resistance welding does not meet a certain standard of quality for a weld, the resistance welding can be redone. The pair of metal tabs 604 may be cut off or trimmed at the cutting locations 702. The resistance welding may then be redone or a wire bond may then be used to replace the resistance welding. In some embodiments, the gap 704 between the pair of metal tabs 604 may also improve the quality of bond from resistance welding. The zoomed-in view 750 depicts the other side of the second collector plate 310 integrated with the second cell holder 308. In some embodiments, the view 750 is shown to include dents 706 and rigid bumps 708 on each of the pairs of metal tabs 604. The dents 706 in each recess of the second cell holder 308 for one of the battery cells 306 may provide venting for an end (e.g., a positive end or negative end) of the battery cells 306. The rigid bumps 708 on the pair of metal tabs 604 may provide a better welding surface during resistance welding of the second ends of battery cells 306 to the second collector plates 310.

Referring now to FIG. 8, a perspective view 800 of battery cell assembly 204 in the core battery pack 105 is shown, according to an exemplary embodiment. The perspective view 800 shows the arrangement of the battery cells 306 within the core battery pack 105. The battery cells 306 may be arranged in a 7P14S configuration (i.e., seven battery cells in parallel, and fourteen series of battery cells). The series of battery cells 306 may build up the voltage of the core battery pack 105 to reach a certain rating of voltage (e.g., 48V). In other embodiments, the core battery pack 105 may include more or less battery cells 306 to provide a different voltage rating for use with a specific type of power equipment. In some embodiments, the core battery pack 105 may include a different amount of battery cells 306 to change the charge capacity (W-hrs), or to change both the voltage and the charge capacity. The view 800 is also shown to include BMS 312 located proximate a top portion of the core battery pack 105. In some embodiments, the battery cells 306 alternate positive and negative sides to improve the ability to route the voltage measurements through the battery cell assembly 204 to other components of the core battery pack 105. For example, the positive side of the battery cell 306 in the seventh series is electrically connected to the negative side of the neighboring battery cell 306 that is in the sixth series of battery cells 306. In some embodiments, half of the battery cells 306 in series are separated from the other half of battery cells 306 by spacers 206 and flexible O-rings to provide support and damping of impacts to the core battery pack 105.

Referring now to FIGS. 9A and 9B, side perspective views of the assembly of the battery cells 306 with the first and second collector plates 302 and 310 are shown, according to some embodiments. Referring specifically to FIG. 9A, the view 900 shows the cell arrangement of the battery cells 306 in the second half of the fourteen series in the core battery pack 105 and how the battery cells 306 are connected to the neighboring battery cells 306 (shown with the red line). For example, the positive side of the eighth series of battery cells 306 is electrically connected to the negative side of the seventh series of battery cells 306 and the negative side of the fourteenth series of battery cells 306 is electrically connected to the negative side of the cable assembly 210.

Referring particularly to FIG. 9B, the perspective side view 950 shows the cell arrangement of the battery cells 306 in the first half of the fourteen series of the core battery pack 105, according to an exemplary embodiment. The view 950 also shows the connections (shown in red) between the different series of battery cells 306. Additionally, the side view 950 includes the several voltage taps that are electrically coupled to the first collector plates 302 and the second collector plates 310. In some embodiments, the first collector plates 302 are electrically connected to the voltage taps 952, 954, 956, 958, 960, 962, and 964 for measuring voltages of the ground, the twelfth series, the second series, the tenth series, the fourth series, the eighth series, and the sixth series, respectively. In some embodiments, the second collector plates 310 are electrically connected to the voltage taps 966, 968, 970, 972, 974, 976, and 978 for measuring voltages of the seventh series, the ninth series, the fifth series, the eleventh series, the third series, the thirteenth series, and the first series of battery cells 306, respectively. In some embodiments, a wire connecting from the MOSFET board 314 to the fourteenth series provides the voltage reading of the fourteenth series of battery cells 306. The BMS 312 may couple to the apertures in each of the voltage taps shown in FIG. 9B using self-tapping screws and adhesive. In some embodiments, the BMS 312 receives voltage readings of the plurality of battery cells 306 via the corresponding voltage taps coupled to the first collector plates 302 and the second collector plates 310. In some embodiments, the voltage taps coupled to the second collector plates 310 are made of nickel-plated steel. In some embodiments, the voltage taps connected to the first collector plates 302 are made of aluminum. In other embodiments, the voltage taps on both sides of the battery cell assembly 204 are both constructed from the same type of material.

Referring now to FIG. 10, a bottom view 1000 of the first cell holder 304 is shown, according to an exemplary embodiment. The bottom view 1000 depicts fingers 1002 and dents 1004 in each of the positions for the battery cells 306 in the first cell holder 304. The first cell holder 304 may be a plastic component that is structured to hold and position the battery cells 306 using the plastic fingers 1002. In some embodiments, the fingers 1002 may allow the first cell holder 304 to latch on and grab each corresponding battery cell 306 in the core battery pack 105. The fingers 1002 may help secure the battery cells 306 to the first cell holder 304 and help control the positioning of each of the battery cells 306. Furthermore, the fingers 1002 may hold and retain each of the battery cells 306 during manufacturing and assembly of the core battery pack 105. The use of the fingers 1002 with the resistance welding on the second side of the battery cell assembly 204 may allow the core battery pack 105 to be manufactured without the use of glue. In addition, the press-fit function of the fingers 1002 may help position the battery cells 306 during manufacturing. The use of the fingers 1002, along with the resistance welding of the second ends of the battery cells 306 to the second collector plates 310, may eliminate the need for curing. Additionally, the cycle time during assembly of the battery cell assembly 204 can be reduced. In some embodiments, the fingers 1002 allow battery cells 306 of different sizes to be used. For example, the fingers 1002 may permit battery cells 306 with varying dimensions in diameter to be utilized in the core battery pack 105. The fingers 1002 can accommodate other cylindrical cells that have a marginal difference in the as designed outside diameter and/or the tolerance of the battery cells 306. As such, improved types of battery cells 306 may be used in the design of the core battery pack 105 without having to redesign the first cell holder 304. In some embodiments, the dents 1004 in each position for one of the battery cells 306 allow venting of a first end (e.g., a positive side or negative side) of the battery cells 306 in order to couple to a first collector plate 302. In some embodiments, the first cell holder 304 includes twelve locations for fasteners, such as screws, to fasten the first cell holder 304 to the first collector plates 302.

Referring now to FIG. 11, the second cell holder 308 of the core battery pack 105 is shown in greater detail, according to one embodiment. In some embodiments, the perspective view 1100 is a close up view of several individual positions for the battery cells 306 in the second cell holder 308. In some embodiments, each location for a battery cell 306 includes a rigid structure 1102 on an interior surface of the location for one of the battery cells 306. The rigid structures 1102 may be rounded bumps on the surface of the recess in the battery cell holder 308 that hold the battery cells 306. The rigid structures 1102 may increase control over the position of each of the battery cells 306 placed in the second cell holder 308. In some embodiments, each individual position for one of the battery cells 306 includes six rigid structures 1102. Each rigid structure 1102 may be evenly spaced out around the circumference of each recess in the second cell holder 308.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

It should be understood that while the use of words such as desirable or suitable utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” or “at least one” are used there is no intention to limit the claim to only one item unless specifically stated to the contrary in the claim.

It should be noted that certain passages of this disclosure can reference terms such as “first” and “second” in connection with side and end, etc., for purposes of identifying or differentiating one from another or from others. These terms are not intended to merely relate entities (e.g., a first side and a second side) temporally or according to a sequence, although in some cases, these entities can include such a relationship. Nor do these terms limit the number of possible entities (e.g., sides or ends) that can operate within a system or environment.

The terms “coupled” and “connected” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

1. A battery pack for powering equipment comprising:
a core battery pack, the core battery pack including:
a housing; and
a battery cell assembly positioned within the housing of the core battery pack, the battery cell assembly comprising;
a first collector plate and a second collector plate;
a plurality of battery cells, wherein each of the plurality of battery cells defines a first end and a second end; and
a plurality of wire bonds;
wherein each of the plurality of wire bonds electrically connects the first end of a respective one of the plurality of battery cells to the first collector plate;
wherein the second end of each of the plurality of battery cells is coupled to the second collector plate by a resistance weld.

2. (canceled)

3. The battery pack of claim 1, wherein each of the resistance welds is configured to provide an electrical connection for routing a voltage measurement to a battery management system (BMS).

4. The battery pack of claim 1, wherein the second collector plate includes a pair of removable metal tabs coupled to the second end of each of the plurality of battery cells.

5. The battery pack of claim 1, wherein the battery pack further comprises a first cell holder and a second cell holder, wherein the first collector plate is overmolded into the first cell holder and the second collector plate is overmolded into the second cell holder.

6. The battery pack of claim 5, wherein each of the plurality of battery cells is positioned and held within the first cell holder by a plurality of fingers extending from the first cell holder.

7. (canceled)

8. The battery pack of claim 1, wherein the first end and the second end of each of the plurality of battery cells are secured to the first collector plate and the second collector plate, respectively, without use of glue.

9. The battery pack of claim 1, wherein the first collector plate and the second collector plate are electrically coupled to a battery management system (BMS) via a plurality of voltage taps for measuring a voltage of the plurality of battery cells.

10. The battery pack of claim 9, wherein the BMS is configured to at least one of control usage of the battery pack, detect faults in the battery cell assembly, and balance charges of the plurality of battery cells based on the voltage readings.

11. (canceled)

12. The battery pack of claim 1, wherein the battery pack comprises:
a first housing attached to the core battery pack, the first housing including a handle; and
a second housing attached to the core battery pack;
wherein the second housing includes a first bumper module and a second bumper module; and
wherein the second housing is configured to dampen a force experienced by the core battery pack.

13. A battery pack comprising:
a housing;
a battery cell assembly, the battery cell assembly comprising;
a first collector plate and a second collector plate;
a plurality of battery cells, wherein each of the plurality of battery cells defines a first end and a second end; and
a first cell holder, wherein each of the plurality of battery cells is positioned and held within the first cell holder by a plurality of fingers extending from the first cell holder;
wherein the first end of each of the plurality of battery cells is physically and electrically connected to the first collector plate by a wire bond.

14. The battery pack of claim 13, wherein the second end of each of the plurality of battery cells is coupled to the second collector plate by a resistance weld.

15. The battery pack of claim 14, wherein each of the resistance welds is configured to provide an electrical connection for routing a voltage measurement to a battery management system (BMS).

16. The battery pack of claim 13, wherein the second collector plate includes a pair of removable metal tabs coupled to the second end of each of the plurality of battery cells.

17. The battery pack of claim 13, wherein the first end and the second end of each of the plurality of battery cells are secured to the first collector plate and the second collector plate, respectively, without use of glue.

18. The battery pack of claim 13, wherein the first cell holder is fabricated from a plastic material.

19. (canceled)

20. The battery pack of claim 13, wherein the first collector plate and the second collector plate are electrically coupled to a battery management system (BMS) via a plurality of voltage taps for measuring a voltage of the plurality of battery cells.

21. The battery pack of claim 20, wherein the BMS is configured to at least one of control usage of the battery pack, detect faults in the battery cell assembly, and balance charges of the plurality of battery cells based on the voltage readings.

22. (canceled)

23. A battery pack for powering equipment comprising:
a core battery pack including a housing;
a battery cell assembly positioned within the housing of the core battery pack, the battery cell assembly comprising;
a first collector plate and a second collector plate;
a plurality of battery cells; and
a battery management system (BMS);
wherein the first collector plate and the second collector plate are electrically connected to the BMS via a plurality of voltage taps for measuring voltage readings of the plurality of battery cells.

24. The battery pack of claim 23, wherein the first end of each of the plurality of battery cells is physically and electrically connected to the first collector plate by a wire bond, and wherein the second end of each of the plurality of battery cells is coupled to the second collector plate by a resistance weld.

25. The battery pack of claim 23, further comprising a first cell holder, wherein each of the plurality of battery cells is positioned and held within the first cell holder by a plurality of fingers extending from the first cell holder.
